(19) United States
(12) Patent Application Publication
(10) Pub. No.: US 2022/0306259 A1
(43) Pub. Date: Sep. 29, 2022

(54) DRIVE FOR A VEHICLE, WATERCRAFT HAVING A DRIVE OF THIS TYPE, METHOD FOR OPERATING A WATERCRAFT, AND CONTROL DEVICE FOR A WATERCRAFT OF THIS TYPE

(71) Applicant: Rolls-Royce Solutions GmbH, Friedrichshafen (DE)

(72) Inventors: Jan Boyde, Friedrichshafen (DE); Marcus Fackler, Ravensburg (DE); Mario Dittmann, Friedrichshafen (DE)

(73) Assignee: Rolls-Royce Solutions GmbH, Friedrichshafen (DE)

(21) Appl. No.: 17/842,422

(22) Filed: Jun. 16, 2022

Related U.S. Application Data
(63) Continuation of application No. PCT/EP2020/086271, filed on Dec. 15, 2020.

(30) Foreign Application Priority Data
Dec. 16, 2019 (DE) 10 2019 219 770.1

(51) Int. Cl. B63H 21/20; B63H 23/16; B63H 21/21

(52) U.S. Cl. CPC B63H 21/20; B63H 23/16; B63H 21/21; B63H 2021/205

(57) ABSTRACT

A drive for a vehicle includes: an internal combustion engine; a freewheel device, a drive shaft, the internal combustion engine configured for being drive-operatively connected to the drive shaft of the drive via the freewheel device, the freewheel device being configured to decouple the internal combustion engine from the drive shaft if a rotational speed of the drive shaft exceeds a rotational speed of the internal combustion engine; and a bridging device which is designed to couple the internal combustion engine to the drive shaft in at least one operating situation of the drive if the internal combustion engine is separated from the drive shaft by the freewheel device.

### CROSS REFERENCE TO RELATED APPLICATIONS

This is a continuation of PCT application no. PCT/EP2020/086271, entitled “DRIVE FOR A VEHICLE, WATERCRAFT HAVING A DRIVE OF THIS TYPE, METHOD FOR OPERATING A WATERCRAFT, AND CONTROL DEVICE FOR A WATERCRAFT OF THIS TYPE”, filed Dec. 15, 2020, which is incorporated herein by reference. PCT application no. PCT/EP2020/086271 claims priority to German patent application no. 10 2019 219 770.1, filed Dec. 16, 2019, which is incorporated herein by reference.

### BACKGROUND OF THE INVENTION

### 1. Field of the Invention

The present invention relates to a drive for a vehicle, a watercraft having such a drive, a method for operating such a watercraft, and a control device for such a watercraft.

### 2. Description of the Related Art

With vehicles, especially watercraft, there is the fundamental problem to decelerate them rapidly and with as short a deceleration distance as possible, especially from full speed. In particular, such a watercraft should be able to be stopped within the shortest possible time and distance in order to avoid collisions wherever possible. There is a general need to improve the deceleration behavior.

What is needed in the art is a drive for a vehicle, a watercraft having such a drive, a method for operating a watercraft, and a control device for such a watercraft optionally.

### SUMMARY OF THE INVENTION

that the present invention provides a drive, in particular motorized, for a vehicle, in particular a watercraft, including an internal combustion engine and a freewheel device. The internal combustion engine can be drive-operatively connectable via the freewheel device with a drive shaft of the drive, in particular is drive-operatively connected. The freewheel device is designed to uncouple the internal combustion engine from the drive shaft, in other words, to disconnect the active drive connection, when a rotational speed of the drive shaft exceeds a rotational speed of the internal combustion engine. The fact that the internal combustion engine can be drive-operatively connected to the drive shaft via the freewheel device means in particular that the active drive connection between the internal combustion engine and the drive shaft can be closed and separated by the freewheel device. In particular, the internal combustion engine can be decoupled from the drive shaft by the freewheel device.

In this arrangement, in particular when using the drive in a vehicle, in particular a watercraft, the need may arise for example in an operating situation of the vehicle in which, originating from a forward travel, the direction of rotation of a propeller shaft that is operatively connected to the drive shaft is to be reversed, for example in order to decelerate the vehicle, whereby the internal combustion engine is operated in idle mode or is switched off in order to reduce a rotational speed of the propeller shaft, hereinafter also referred to as propeller shaft rotational speed, first of all by the acting water forces, before the propeller shaft is then driven in opposite direction of rotation. In this case, during the reduction of the propeller shaft rotational speed, a rotational speed assigned to the propeller shaft—this means in particular the rotational speed of the drive shaft—exceeds the rotational speed of the internal combustion engine, so that the internal combustion engine is decoupled from the propeller shaft.

Provision is made, that the drive includes a bridging device which is designed to couple the internal combustion engine to the drive shaft in at least one operating situation of the drive, in particular in at least one operating situation of the vehicle if the internal combustion engine is separated from the drive shaft by the freewheel device. In particular, when used in a watercraft, the bridging device is designed to couple the internal combustion engine in at least one operating situation of the watercraft with the propeller shaft if the internal combustion engine is separated from the propeller shaft by the freewheel device.

It is thus particularly advantageously possible to couple the internal combustion engine with the drive shaft by way of the bridging device also in an operating situation wherein the rotational speed of the drive shaft exceeds the rotational speed of the internal combustion engine. This may be exploited in a vehicle in particular to reduce the rotational drive shaft speed more quickly, in particular the propeller shaft rotational speed in a watercraft, especially if the propeller shaft is to be reversed from a first direction of rotation to a second, opposite direction of rotation, whereby the propeller shaft then drags the internal combustion engine. Thus, a torque reducing its rotational speed is introduced advantageously by the internal combustion into the drive shaft, in particular the propeller shaft. The herein proposed design therefore, enables faster deceleration of the vehicle, in particular since it is possible to switch more quickly from one direction of rotation of the propeller shaft to the opposite direction of rotation in order to then actively decelerate the vehicle. In this way, in particular, the time and distance for stopping the vehicle are reduced, so that collisions can be more successfully be avoided.

The drive shaft is in particular an output shaft or pinion shaft of the drive, that is, in particular a shaft from which the mechanical power of the drive can be taken or where the drive makes mechanical power available.

A freewheel device is generally understood to be a device which enables decoupling of the drive shaft from the internal combustion engine when the rotational speed of the drive shaft exceeds the rotational speed of the internal combustion engine. The freewheel device does not necessarily have to be designed as a mechanical freewheel; rather, it is sufficient for the freewheel device to provide the corresponding function, regardless of the specific design of the provision of this function. From the point of view of the internal combustion engine, the freewheel device acts like an overrunning gearing: as soon as the rotational speed of the internal combustion engine is lower than the rotational speed of the drive shaft, the internal combustion engine is in a freewheeling mode.

The bridging device is designed in particular to bridge the freewheel device. This means in particular, that the bridging device can couple the internal combustion engine with the drive shaft if the internal combustion engine is actually decoupled from the drive shaft via the freewheeling device. The drive includes the bridging device in particular in addition to the freewheel device, meaning in particular that the bridging device is not identical to the freewheel device. According to an optional design, the drive includes the bridging device separately from the freewheel device.

According to one optional embodiment the at least one operating situation of the drive, in particular of the water vehicle, wherein the bridging device couples the internal combustion engine with the drive shaft is—as already explained—switching from a first direction of rotation of the propeller shaft of the watercraft to a second direction of rotation of the propeller shaft, in particular switching from a forward travel to reverse travel or vice versa; optionally in particular switching from a “full power ahead” operating mode to a “full power reverse” or vice versa, or switching from any desired operating state in regard to travel in a certain direction into a full power operating state regarding travel in the opposite direction, for example from forward travel—regardless of whether this occurs without drive, at a quarter power, at half power or at full power—to reverse travel at full power.

It is especially optional if the at least one operating situation is a braking situation of the vehicle, in particular of the watercraft, wherein the vehicle—optionally at maximum power—is to be decelerated. In an especially optional design the at least one braking situation is an emergency stop situation, wherein the vehicle is to be stopped in the shortest possible time and over the shortest distance, due to a danger situation.

The fact that one element is operatively connectable or is operatively connected with another element means in particular that between the one element and the other element a torque transmitting connection can be formed or is formed.

According to a further advancement of the invention it is provided that the drive in addition includes an electric machine, wherein the internal combustion engine and the electric machine are drive-operatively connectable with the drive shaft via the freewheel device in such a way, that only the internal combustion engine, only the electric machine, or the internal combustion engine and the electric machine together can drive the drive shaft. The drive is in particular designed such, that in a first operating state of the drive only the internal combustion engine, in a second operating state of the drive only the electric machine and in a third operating state of the drive the internal combustion engine and the electric machine together can drive the drive shaft. The drive is optionally designed as a hybrid drive. In particular, the internal combustion engine and the electric machine act upon the same drive shaft, in particular upon the same propeller shaft of the watercraft.

The freewheel device is designed, in particular, to decouple the internal combustion engine from the drive shaft when the rotational speed of the drive shaft that is driven by the electric machine exceeds the rotational speed of the internal combustion engine. Thus, the functionality is advantageously realized that the internal combustion engine is decoupled from the drive shaft when the drive load is primarily applied by the electric machine.

Optionally, in the at least one operating situation in which the internal combustion engine is coupled to the drive shaft via the bridging device, the electric machine is controlled to actively slow down the speed of the drive shaft.

A hybrid drive enables special types of deceleration for the vehicle. The presence of two drive modes—namely the internal combustion engine on the one hand and the electric machine on the other hand—the advantages of both drive modes can be combined. Primarily, the high torque at low rotational speeds of the electric machine facilitates clearly more efficient braking than by way of the internal combustion engine alone. The herein proposed design exploits the potential of both drive modes for the best possible braking action.

The drive optionally includes an electric storage device which is arranged to optionally store or provide electric energy. The electrical storage device is optionally operatively connected to the electric machine in order to store—depending on the operating state of the drive, in particular depending on the operating state of the vehicle—kinetic energy of the vehicle that is converted into electrical energy by the electric machine operated as a generator, in other words to store in particular recuperated energy, or to use stored energy for the operation of the electric machine as a motor.

According to a further development of the invention it is provided that the freewheel device is designed as a mechanical freewheel. This represents an especially simple design of the freewheel device.

Alternatively it is optionally provided that the freewheel device is designed as a transmission mechanism or as part of a transmission mechanism. This represents a more complex design of the freewheel device which advantageously allows the realization of a greater number of operating states. The freewheel device can in particular be designed as planetary gearing. Two electric motors are optionally operatively connected with the planetary gearing. With this constellation, where the internal combustion engine and two electric machines interact with a planetary gearing, many diverse operating states can be realized.

The freewheel device can be designed in particular as an intermediate gear unit or as part of an intermediate gear unit or can be positioned before an intermediate gear—on the input side on the side of the internal combustion engine.

According to a further development of the invention it is provided, that the bridging device is arranged on the freewheel device. Alternatively it is optionally provided, that the bridging device is integrated into the freewheel device. Alternatively it is optionally provided that the bridging device is arranged parallel to the freewheel device. Each of these alternatives facilitates an especially compact and at the same time effective configuration of the bridging device inside the drive.

According to a further development of the invention it is provided, that the bridging device is designed as a coupling. This represents an especially simple and effective design of the bridging device. In an optional arrangement the bridging device is designed as a magnetic coupling. This represents an equally simple and functionally reliable design of the bridging device.

The objective is also met in that a watercraft is being created that includes a drive according to the invention or a drive according to one of the previously described design examples, wherein the drive shaft is a propeller shaft of the watercraft, or wherein the drive shaft can be drive-operatively connected, or is drive-operatively connected with the propeller shaft of the watercraft. In connection with the watercraft, advantages result which were already previously discussed in connection with the drive.

In particular, a watercraft is optional in which the internal combustion engine of the drive can be drive-operatively connected to the propeller shaft via the freewheeling device. The freewheel device is designed to decouple the internal combustion engine from the propeller shaft when the rotational speed assigned to the propeller shaft exceeds the rotational speed of the internal combustion engine. The bridging device is designed to couple the internal combustion engine in at least one operating situation of the watercraft with the propeller shaft, when the internal combustion engine is separated by the freewheel device from the propeller shaft.

A watercraft is understood to be in particular a vehicle which is intended for movement on or in the water. In particular, the watercraft has its own drive, in other words, it is self-propelled. In an optional embodiment, such a watercraft is in particular a ship, a boat, or a raft. The watercraft can however also be an amphibious vehicle, a personal watercraft, a jet ski, or a similar vehicle. In an especially optional embodiment, the watercraft is a yacht.

The rotational speed assigned to the propeller shaft is in particular understood to be a rotational speed which, from the perspective of the internal combustion engine is characteristic for an angular velocity of the propeller shaft and/or is clearly associated with the angular velocity of the propeller shaft. In particular, the rotational speed assigned to the propeller shaft is the rotational speed of the drive shaft which is either drive-operatively connected to the propeller shaft—possibly transmitted via at least one transmission gearbox—or which is identical to the propeller shaft. The drive shaft is in particular a shaft which, when the internal combustion engine is coupled with the propeller shaft via the freewheel device has the same rotational speed as the internal combustion engine. If the drive shaft is connected with the propeller shaft via at least one transmission gearbox it is possible that the rotational speed of the drive shaft and thereby at the same time the rotational speed assigned to the propeller shaft deviates from the rotational speed of the propeller shaft also referred to as propeller shaft rotational speed, wherein the deviation is determined by the at least one transmission gearbox. If, on the other hand the drive shaft is identical to the propeller shaft, and thus the internal combustion engine in a coupled state is directly coupled with the propeller shaft, the rotational speed assigned to the propeller shaft is identical to the rotational speed of the propeller shaft and thus at the same time with that of the drive shaft; this means that the rotational speed assigned to the propeller shaft in this case is the propeller shaft rotational speed.

The propeller shaft is optionally coupled to a propeller of the watercraft, whereby the propeller is optionally connected to the propeller shaft in a rotationally fixed manner.

According to a further development of the invention it is provided that a shift transmission is arranged between the freewheel device and the propeller of the watercraft which is designed to reverse a rotational direction of the propeller relative to a rotational direction of the internal combustion engine, when the shift transmission is shifted. This facilitates especially easy changing of the rotational direction of the propeller while maintaining the direction of rotation of the internal combustion engine. It is therefore not necessary to reverse the internal combustion engine in order to change the direction of rotation of the propeller.

In particular, two operating states for the watercraft are presented by the shift transmission, namely forward motion, and reverse motion.

The freewheel device is designed as an intermediate gear unit or as part of an intermediate gear unit, in particular if the watercraft additionally includes such a shift transmission. The shift transmission is optionally arranged between the freewheel device, in particular the intermediate gear unit on the one hand and the propeller on the other hand.

Optionally, a clutch is provided between the freewheel device and the shift transmission, in particular between the intermediate gear unit and the shift transmission. By way of this clutch, the internal combustion engine and the electric machine can optionally be decoupled from the shift transmission, and thereby at the same time also from the propeller. This makes it possible to gently and quickly switch over the shift transmission.

The drive shaft is optionally a transmission input shaft of the shift transmission. Alternatively, the drive shaft is optionally an input shaft of the clutch. The term “input” refers herein always to a side facing toward the internal combustion engine. Accordingly, a side facing toward the propeller is referred to as “output”.

The watercraft optionally has two propeller shafts and two—optionally equal in design, in particular identically designed—drives according to the invention or drives according to one of the previously described design examples, wherein each propeller shaft respectively has a separate drive assigned to it. It is also possible that the watercraft has more than two propeller shafts and more than two—in particular identical—drives. It is advantageous, particularly with larger or more powerful watercraft if they have more than one propeller shaft and more than one drive.

The present invention also provides a method for operating a watercraft according to the invention or a watercraft according to one of the previously described design examples, wherein, during a braking maneuver to reduce the propeller shaft rotational speed, the bridging device closes, so that the internal combustion engine is coupled with the propeller shaft and is dragged by the propeller shaft. Within the scope of the method, advantages are in particular realized, which herein were already explained in connection with the drive and the watercraft.

The braking maneuver is optionally an emergency stop maneuver. Optionally, in the course of the braking maneuver—in particular after reducing the propeller shaft rotational speed—the drive is operated at full power in the direction opposite to the previous direction of travel, for example full power reverse in the case of previous forward travel, or vice versa.

A further development of the invention provides that prior to the braking maneuver the watercraft is driven only by the internal combustion engine, or by the electric machine and the internal combustion engine together, wherein the following steps are performed for the braking maneuver: a) fuel supply to the internal combustion engine is stopped; b) the previously opened bridging device is being closed; c) the electric machine is controlled to reduce the propeller shaft rotational speed, optionally with maximal power. This means in particular that the electric machine is controlled in such a way that the propeller shaft rotational speed is reduced as a result of the control of the electric machine. By way of the procedure described here, the propeller shaft rotational speed can be reduced especially efficiently and quickly, enabling the braking maneuver to be carried out while shortening the time and distance to the danger point, in particular a possible collision.

The internal combustion engine has in particular at least one combustion chamber. The fact that the fuel supply is stopped means in particular that no more fuel is supplied to the at least one combustion chamber of the internal combustion engine. In particular, in the case of an internal combustion engine designed as a diesel engine, fuel injection is stopped.

In the herein proposed procedure, the drag torque of the internal combustion engine and the torque of the electric machine—in particular at maximum power—are utilized together in order to advantageously brake the propeller shaft especially quickly.

If during the reduction of the propeller shaft rotational speed the idle speed of the internal combustion engine is reached, the clutch is optionally opened. In an especially optional embodiment, the fuel supply to the internal combustion engine is resumed, so that it runs in idle mode. This serves to avoid a time delay in connection with a restart of the internal combustion engine for the subsequent drive of the propeller in opposite direction. It is, however, basically possible that the fuel supply to the internal combustion engine resumes only after shifting the shift transmission and after closing the clutch. This, however, involves a time delay which is disadvantageous, particularly in an emergency maneuver. If the fuel supply to the internal combustion engine is resumed with an open clutch, the electric machine optionally rotates without a power output with the idle speed of the internal combustion engine.

Now, the shift transmission is shifted optionally in regard to the direction of rotation of the propeller. As soon as this occurs, the clutch is again closed, and the internal combustion engine and the electric machine together accelerate the propeller optionally with respectively full power in the opposite direction to the previous direction of rotation, in order to intensify the braking process. Overall, a particularly effective deceleration of the watercraft can be achieved in this way.

According to a further development of the invention, an alternative arrangement of the method provides, that prior to the braking maneuver the watercraft is driven only by the electric machine, wherein the internal combustion engine is optionally stopped, meaning that the fuel supply to the at least one combustion chamber—in particular to all combustion chambers—is stopped; the internal combustion engine is not running. In this operating state, the internal combustion engine is decoupled from the propeller shaft, in particular by the freewheel device. Now, the following steps are performed for the braking maneuver: the electric machine is controlled—in particular at maximum power—a) to reduce the propeller shaft rotational speed This means in particular, that the electric machine is redirected in regard to its direction of rotation, compared to the previous drive situation. b) The bridging device is being closed. Thereupon the internal combustion engine also brakes the propeller shaft with its friction torque.

If in turn, the rotational speed assigned to the propeller shaft falls below the idle speed of the internal combustion engine, the clutch is optionally opened. At the same time, the fuel supply to the internal combustion engine is optionally resumed, that is, the internal combustion engine is started, wherein it runs in idle mode. As explained above, this optionally serves to avoid a time delay, in particular in connection with an emergency maneuver. In this case, the electric machine rotates with the idle speed of the internal combustion engine, even without power output.

The shift transmission is now optionally shifted and as soon as this process is completed, the clutch is closed. The internal combustion engine and the electric machine now accelerate the propeller together—optionally respectively with maximum power—in the direction of rotation opposite to the previous direction of rotation, in order to intensify the braking process.

The present invention also provides a control unit for a watercraft, which is arranged to carry out a method according to the invention, or a method according to one of the previously described embodiments. In connection with the control unit the previously described advantages arise, in particular in connection with the drive, the watercraft and the method.

According to a further development of the invention, the watercraft has a control unit or a control unit according to one of the previously described design examples which are operatively connected with the bridging device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of a drive and a design example of a watercraft;

FIG. 2 is a schematic representation of a first embodiment of a method for operating a watercraft; and

FIG. 3 is a schematic representation of a second embodiment of the method for operating a watercraft.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

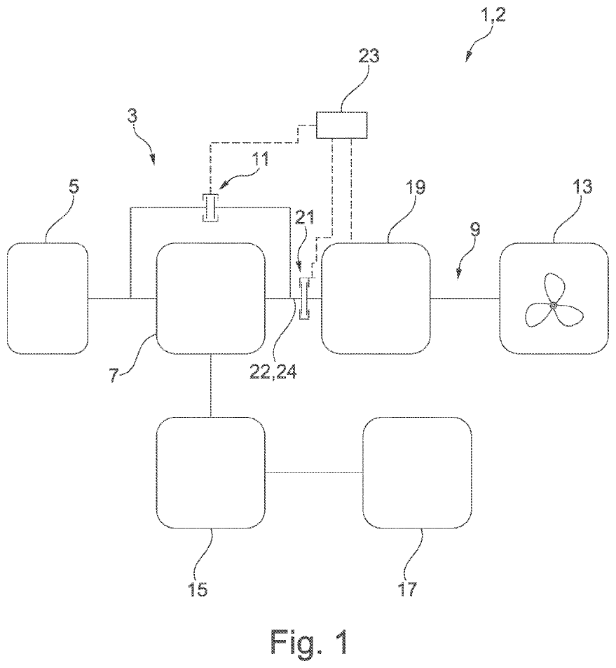

FIG. 1 shows a schematic representation of a design example of a vehicle 2, herein in particular of a watercraft 1, which shows a design example of a drive 3. Drive 3 includes an internal combustion engine 5, optionally a diesel engine, wherein internal combustion engine 5 is drive-operatively connectable via a freewheel device 7 with a propeller shaft 9. Freewheel device 7 is arranged to decouple internal combustion engine 5 from propeller shaft 9, if a rotational speed assigned to propeller shaft 9 exceeds a rotational speed of internal combustion engine 5. Drive 3 moreover includes a bridging device 11 which is designed to couple internal combustion engine 5 with propeller shaft 9 in at least one operating situation of watercraft 1, if combustion engine 5 is separated from propeller shaft 9 by way of freewheel device 7. This makes it possible in an advantageous manner, in particular, that combustion engine 5 when braking propeller shaft 9 can be dragged by propeller shaft 9, wherein the friction torque of internal combustion engine 5 additionally contributes to braking of propeller shaft 9. Therefore, braking maneuvers, especially optionally emergency stop maneuvers of watercraft 1 can be expedited, that is, a time and distance over which watercraft 1 is stopped can be shortened.

A propeller 13 is optionally connected with propeller shaft 9 in a rotationally fixed manner.

Drive 3 also includes an electric machine 15. Internal combustion engine 5 and electric machine 15 are both drive-operatively connectable with propeller shaft 9 via freewheel device 7, namely in such a way that, in a first operating state only internal combustion engine 5, and in a second operating state only electric machine 15, and in a third operating state, internal combustion engine 5 and electric machine 15 can drive propeller shaft 9 together, insofar, drive 3 is designed as a hybrid drive.

An electric storage 17, in particular an accumulator or a battery, is operatively connected with electric machine 15. Electric machine 15 can—depending on the respective operating state of drive 3—be operated as a motor or as a generator. Specifically, when it is operated as a motor it draws electric energy from electric storage 17, and when operated as a generator it feeds electric energy into electric storage 17.

Freewheel device 7 is optionally designed as mechanical freewheel, as a transmission mechanism or as part of a transmission mechanism. Freewheel device 7 can in particular also be designed as planetary gearing to which in addition another electric machine is connected.

A shift transmission 19 is optionally arranged between freewheel device 7 and propeller 13, which is designed to reverse a direction of rotation of propeller 13 relative to a direction of rotation of internal combustion engine 5, when shift transmission 19 is shifted. In particular, two functions can be implemented with shift transmission 19. In other words, one can switch between two operating states of drive 3, namely between forward and reverse drive of watercraft 1. It is possible that shift transmission 19 also has a plurality of different gears, that is different transmission ratios between the rotational speed of internal combustion engine 5 on the one hand and the rotational speed of propeller 13 on the other hand.

Between freewheel device 7 and shift transmission 19 a clutch 21 is optionally arranged, which is designed to optionally connect freewheel device 7 and thus at the same time in particular internal combustion engine 5 with shift transmission 19 or separate from shift transmission 19. Clutch 21 can in particular be designed as a hydraulic or an electric clutch, permitting especially comfortable and in particular also automated control of clutch 21.

The rotational speed assigned to propeller shaft 9 which ultimately determines in comparison to the rotational speed of internal combustion engine 5, whether internal combustion engine 5 is coupled with propeller shaft 9 via freewheel device 7 or not, is in particular the rotational speed of a drive shaft 22 which, in the herein illustrated design example is an input shaft of clutch 21. Depending on the design of shift transmission 19, this rotational speed of drive shaft 22 can correspond with the rotational speed of propeller shaft 9, that is with the propeller shaft rotational speed. It may however deviate from this, particularly if shift transmission 19 is designed as a step-up or step-down transmission. In another embodiment of watercraft 1, it is possible for propeller shaft 9 to be coupled to internal combustion engine 5, in particular without an intermediate shift transmission in such a way that propeller shaft 9 and internal combustion engine 5 have an identical rotational speed in the coupled state. Drive shaft 22 is in this case in particular, propeller shaft 9, and the rotational speed assigned to propeller shaft 9 is directly the propeller shaft rotational speed.

In an optional embodiment, freewheel device 7 is designed as an intermediate gear unit.

Bridging device 11 is optionally arranged on freewheel device 7 or integrated into freewheel device 7. According to the herein illustrated design example of watercraft 1 and drive 3, bridging device 11 is arranged parallel to freewheel device 7.

Bridging device 11 is optionally designed as a coupling, in particular as a magnetic coupling.

It is possible that watercraft 1 has two identically designed drives 3, which are placed optionally parallel to and separately from one another, optionally one drive on port side and one drive on starboard side. Accordingly, watercraft 1 also has two propellers 13, wherein each propeller 13 has its own drive 3 assigned to it.

Watercraft 1 also has optionally one control unit 23 which is operatively connected with bridging device 11 and which is designed to carry out a procedure which is explained in further detail below. Control unit 23 is moreover operatively connected with clutch 21 and optionally with shift transmission 19. In addition, the control unit is also operatively connected—in a non-illustrated manner—with internal combustion engine 5 and with electric machine 15.

A method for operating watercraft 1 provides that during a braking maneuver to reduce the propeller shaft rotational speed, bridging device 11 is closed, so that internal combustion engine 5 is coupled with propeller shaft 9 and is dragged by propeller shaft 9. In this way, the propeller shaft rotation speed is reduced especially quickly and effectively. Such a braking maneuver is optionally an emergency stop maneuver.

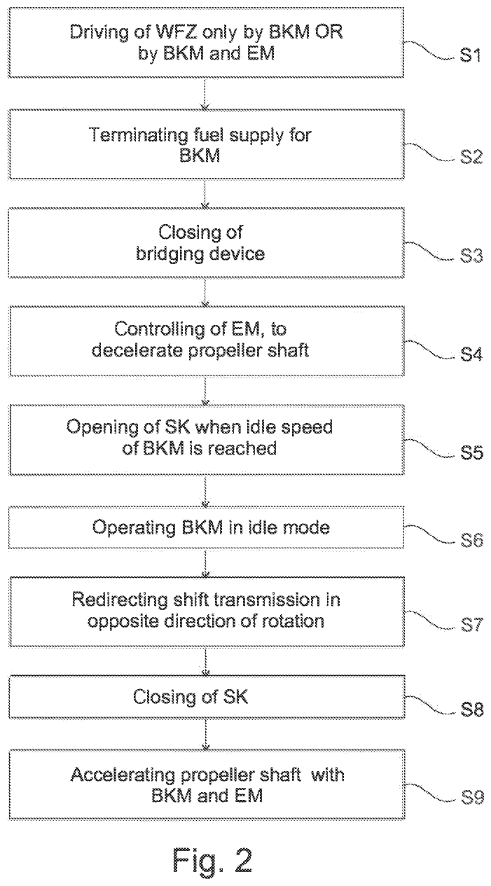

FIG. 2 shows a first embodiment of such a method for operating a watercraft 1.

In a first step S1, watercraft 1 (abbreviated WFZ) is driven prior to the braking maneuver either by only internal combustion engine 5 (abbreviated BKM) or together with internal combustion engine 5 and electric machine 15 (abbreviated EM). In order to initiate the braking maneuver, a fuel supply for internal combustion engine 5, especially injection for the diesel engine, is terminated in a second step 2. In a third step S3, bridging device 11 is closed, so that internal combustion engine 5 is dragged by propeller shaft 9.

In a fourth step S4, electric machine 15 is controlled in order to decelerate propeller shaft 9. Depending on whether electric machine 15 was used previously to drive watercraft 1 or whether it was at rest it is now reversed with respect to its direction of rotation or newly controlled. Optionally, electric machine 15 is controlled at full power in order to decelerate propeller shaft 9 as quickly as possible, that is, to reduce its rotational speed. Combustion engine 5 and electric machine 15 now act together to reduce the propeller shaft rotational speed, wherein a torque is actively introduced into propeller shaft 9 by electric machine 15 and wherein internal combustion engine 5 is passively dragged by propeller shaft 9.

If an idle speed of internal combustion engine 5 is reached, clutch 21 is opened in a fifth step S5. Subsequently, internal combustion engine 5 is operated in idle mode in a sixth step S6.

In a seventh step S7, shift transmission 19 is shifted into a direction of rotation, opposite to the previous direction of rotation, for example from forward motion to reverse, or vice versa.

If shift transmission 19 is shifted, clutch 21 is closed in an eighth step S8. In a ninth step S9, propeller shaft 9 is accelerated—now in opposite direction of rotation—by internal combustion engine 5 together with electric machine 15, optionally respectively at maximum power. In this way, the braking process for watercraft 1 can be performed very efficiently, quickly and over a short distance.

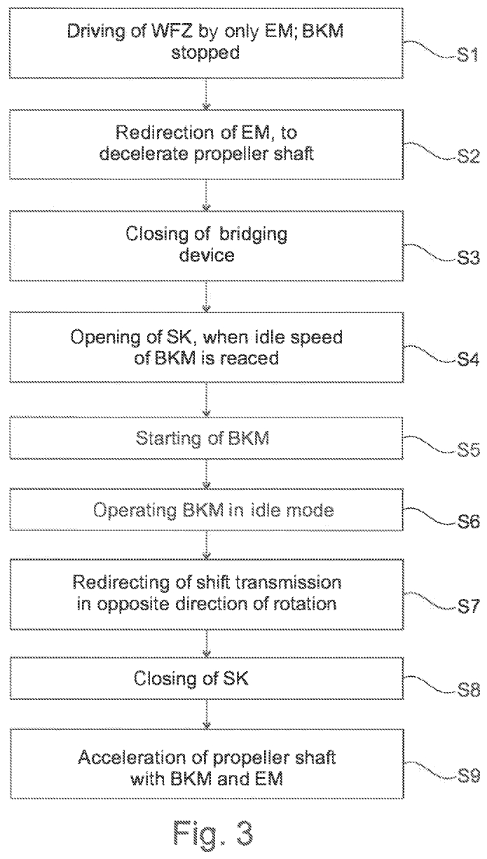

FIG. 3 shows a schematic representation of a second embodiment of the method. In this case, watercraft 1 is driven in a first step S1 prior to the braking maneuver by only electric machine 15. Internal combustion engine 5—in particular the fuel supply to the combustion chamber, in particular to all combustion chambers of internal combustion engine 5—is stopped.

It the braking maneuver is now to be initiated, electric machine 15 is redirected in a second step S2, that is, it is reversed in respect to its direction of rotation in order to decelerate propeller shaft 9. Electric machine 15 is thereby operated optionally at its maximum power, in order to decelerate propeller shaft 9 as quickly as possible. In a third step S3, bridging device 11 is closed, so that internal combustion engine 5 is additionally dragged by propeller shaft 9. As a result, propeller shaft rotational speed is additionally and more quickly reduced, than would be the case if it would be decelerated only by electric machine 15.

When the idle speed of internal combustion engine 5 is reached, clutch 21 is opened in a fourth step S4. Internal combustion engine 5 is started in a fifth step S5 and is operated in idle mode in a sixth step S6.

In a seventh step S7, clutch 21 is shifted into the opposite direction of rotation. Once this has occurred, clutch 21 is closed in an eighth step S8 and, in a ninth step S9, the propeller shaft—now in opposite direction—is accelerated by internal combustion engine 5 and electric machine 15 together, optionally with respectively maximum power. An especially rapid deceleration of watercraft 1 over the shortest possible distance can be achieved also with this embodiment of the method.

In a first embodiment of the method according to FIG. 2, steps S3 and S4 can be performed simultaneously. Also, second step S2 can be performed simultaneously with third step S3 and fourth step S4. In the second embodiment of the method according to FIG. 3, second step S2 and third step S3 can be performed simultaneously.

If, in sixth step S6, according to both embodiments of the method according to FIGS. 2 and 3, internal combustion engine 5 is operated in idle mode, electric machine 15 also rotates in particular without power output with the idle speed of internal combustion engine 5, since it is connected with same via freewheel device 7, in particular via the intermediate gear unit.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drive for a vehicle, the drive comprising:
an internal combustion engine;
a freewheel device,
a drive shaft, the internal combustion engine configured for being drive-operatively connected to the drive shaft of the drive via the freewheel device, the freewheel device being configured to decouple the internal combustion engine from the drive shaft if a rotational speed of the drive shaft exceeds a rotational speed of the internal combustion engine; and
a bridging device which is designed to couple the internal combustion engine to the drive shaft in at least one operating situation of the drive if the internal combustion engine is separated from the drive shaft by the freewheel device.

2. The drive according to claim 1, wherein the drive in addition includes an electric machine, wherein the internal combustion engine and the electric machine are configured for being drive-operatively connected with the drive shaft via the freewheel device in such a way that (a) only the internal combustion engine is, (b) only the electric machine is, or (c) the internal combustion engine and the electric machine together are configured for driving the drive shaft, the drive being for a vehicle formed as a watercraft.

3. The drive according to claim 1, wherein the freewheel device is formed as a mechanical freewheel, as a transmission mechanism, and as a part of a transmission mechanism.

4. The drive according to claim 1, wherein the bridging device is arranged on the freewheel device, is integrated into the freewheel device, or is arranged parallel to the freewheel device.

5. The drive according to claim 1, wherein the bridging device is formed as a coupling, in particular as a magnetic coupling.

6. The drive according to claim 1, wherein the bridging device is formed as a magnetic coupling.

7. A watercraft, comprising:
a drive, including:
an internal combustion engine;
a freewheel device,
a drive shaft, the internal combustion engine configured for being drive-operatively connected to the drive shaft of the drive via the freewheel device, the freewheel device being configured to decouple the internal combustion engine from the drive shaft if a rotational speed of the drive shaft exceeds a rotational speed of the internal combustion engine; and
a bridging device which is designed to couple the internal combustion engine to the drive shaft in at least one operating situation of the drive if the internal combustion engine is separated from the drive shaft by the freewheel device, the drive shaft being a propeller shaft of the watercraft, being configured for being drive-operatively connected with a propeller shaft of the watercraft, or being drive-operatively connected with a propeller shaft of the watercraft.

8. The watercraft according to claim 7, further comprising a shift transmission which is arranged between the freewheel device and the propeller of the watercraft, the shift transmission being configured to reverse a direction of rotation of the propeller relative to a direction of rotation of the internal combustion engine when the shift transmission is shifted.

9. The watercraft according to claim 7, further comprising a control device which is operatively connected with the bridging device, wherein the control device is configured for carrying out a method for operating the watercraft, the method comprising the steps of:
providing that the watercraft includes the drive;
closing the bridging device during a braking maneuver to reduce a rotational speed of the propeller shaft, the internal combustion engine being coupled with the propeller shaft and being dragged by the propeller shaft.

10. A method for operating a watercraft, the method comprising the steps of:
providing that the watercraft includes:
a drive, including:
an internal combustion engine;
a freewheel device,
a drive shaft, the internal combustion engine configured for being drive-operatively connected to the drive shaft of the drive via the freewheel device, the freewheel device being configured to decouple the internal combustion engine from the drive shaft if a rotational speed of the drive shaft exceeds a rotational speed of the internal combustion engine; and
a bridging device which is designed to couple the internal combustion engine to the drive shaft in at least one operating situation of the drive if the internal combustion engine is separated from the drive shaft by the freewheel device, the drive shaft being a propeller shaft of the watercraft, being configured for being drive-operatively connected with a propeller shaft of the watercraft, or being drive-operatively connected with a propeller shaft of the watercraft; and
closing the bridging device during a braking maneuver to reduce a rotational speed of the propeller shaft, the internal combustion engine being coupled with the propeller shaft and being dragged by the propeller shaft.

11. The method according to claim 10, wherein prior to the braking maneuver the watercraft is driven by only the internal combustion engine or by an electric machine of the drive together with the internal combustion engine, wherein the following steps are performed for the braking maneuver:
stopping a fuel supply to the internal combustion engine;
closing the bridging device;
controlling the electric machine to decelerate the propeller shaft.

12. The method according to claim 10, wherein prior to the braking maneuver the watercraft is driven only by an electric machine, wherein the internal combustion engine is stopped, wherein the following steps are performed for the braking maneuver:
redirecting the electric machine to decelerate the propeller shaft; and
closing the bridging device.

13. The method according to claim 10, wherein the watercraft includes a control device configured for carrying out the steps of the method.
